(19) United States
(12) Patent Application Publication
(10) Pub. No.: US 2024/0224248 A1
(43) Pub. Date: Jul. 4, 2024

(54) METHOD AND DEVICE FOR RECEPTION AND TRANSMISSION

(71) Applicant: Samsung Electronics Co., Ltd., Suwon-si (KR)

(72) Inventors: Jingxing FU, Beijing (CN); Feifei SUN, Beijing (CN); Zhe CHEN, Beijing (CN)

(21) Appl. No.: 18/490,164

(22) Filed: Oct. 19, 2023

(30) Foreign Application Priority Data
Jan. 4, 2023 (CN) 202310009767.X

(51) Int. Cl. H04W 72/0453; H04W 52/14; H04W 72/12; H04W 72/232

(52) U.S. Cl. CPC H04W 72/0453; H04W 52/146; H04W 72/12; H04W 72/232

(57) ABSTRACT

A method and a device for reception and transmission are provided, wherein a method performed by a user equipment (UE) in a wireless communication network is provided. The method includes determining a frequency domain resource related to a physical uplink shared channel (PUSCH) transmission based on indication information, and determining a power of the PUSCH transmission for transmitting PUSCH based on the frequency domain resource related to the PUSCH transmission, wherein the frequency domain resource related to the PUSCH transmission includes a frequency domain resource allocated to the PUSCH or a frequency domain resource available for the PUSCH transmission among the frequency domain resource allocated to the PUSCH.

### CROSS-REFERENCE TO RELATED APPLICATION(S)

This application is based on and claims priority under 35 U.S.C. § 119(a) of a Chinese patent application number 202310009767.X, filed on Jan. 4, 2023, in the Chinese Intellectual Property Office, the disclosure of which is incorporated by reference herein in its entirety.

### BACKGROUND

### 1. Field

The disclosure relates to the technical field of wireless communication. More particularly, the disclosure relates to a method and a device for reception and transmission.

### 2. Description of Related Art

In order to meet the increasing demand for wireless data communication services since the deployment of 4^{th} generation (4G) communication systems, efforts have been made to develop improved 5^{th} generation (5G) or pre-5G communication systems. Therefore, 5G or pre-5G communication systems are also called “Beyond 4G networks” or “Post-long term evolution (LTE) systems”.

In order to achieve a higher data rate, 5G communication systems are implemented in higher frequency (millimeter wave (mmWave)) bands, e.g., 60 GHz bands. In order to reduce propagation loss of radio waves and increase a transmission distance, technologies, such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference maycellation, or the like.

In 5G systems, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal multiple access (NOMA), sparse code multiple access (SCMA) and reconfigurable intelligent surface (RIS) as advanced access technologies have been developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide, in the wireless communication system, in order to further improve the data reception performance, the technical solution of the application that improves the power control of the existing uplink (UL) signal, thereby ensuring the transmission performance of data and saving power as much as possible on the premise of ensuring the data transmission performance.

Additional aspects will be set forth in part in the description which follows and, in part, will be apparent from the description, or may be learned by practice of the presented embodiments.

In accordance with an aspect of the disclosure, a method performed by a UE in a wireless communication network is provided. The method includes determining a frequency domain resource related to a physical uplink shared channel (PUSCH) transmission based on indication information, and determining a power of the PUSCH transmission for transmitting PUSCH based on the frequency domain resource related to the PUSCH transmission, wherein the frequency domain resource related to the PUSCH transmission includes a frequency domain resource allocated to the PUSCH or a frequency domain resource available for the PUSCH transmission among the frequency domain resource allocated to the PUSCH.

According to an embodiment of the disclosure, the frequency domain resource allocated to the PUSCH includes a frequency domain resource indicated by a frequency domain resource allocation (FRDA) in the downlink (DL) control information for scheduling the PUSCH or a frequency domain resource configured for the PUSCH utilizing high-layer signaling.

According to an embodiment of the disclosure, the frequency domain resource available for the PUSCH transmission among the frequency domain resource allocated to the PUSCH is determined based on the frequency domain resource allocated to the PUSCH and a frequency domain resource available or unavailable for the PUSCH transmission.

According to an embodiment of the disclosure, the indication information includes at least one of high-layer signaling configuration information, information indicated by media access layer signaling, information indicated by physical layer signaling and information indicated by a reference signal.

According to an embodiment of the disclosure, the method further comprises determining to calculate the power of the PUSCH transmission by using one of the frequency domain resource allocated to the PUSCH or the frequency domain resource available for the PUSCH transmission among the frequency domain resource allocated to the PUSCH, based on a signaling indication or whether a predefined condition being met.

According to an embodiment of the disclosure, the predefined condition includes the PUSCH including a continuous plurality of PUSCHs, and among the continuous plurality of PUSCHs, a frequency domain resource scheduled by the PUSCH including the frequency domain resource unavailable for the PUSCH transmission and an adjacent frequency domain resource scheduled by the PUSCH not including the frequency domain resource unavailable for the PUSCH transmission exist, or the PUSCH including a continuous plurality of PUSCHs, and among the continuous plurality of PUSCHs, one frequency domain resource scheduled by the PUSCH including the frequency domain resource unavailable for the PUSCH transmission exists and the adjacent frequency domain resource scheduled by the PUSCH not including the frequency domain resource unavailable for the PUSCH transmission does not exist.

According to an embodiment of the disclosure, the method further comprises determining a power of each frequency domain resource unit available for the PUSCH transmission among the frequency domain resource allocated to the PUSCH, based on the power of the PUSCH transmission and the frequency domain resource available for the PUSCH transmission among the frequency domain resource allocated to the PUSCH.

According to an embodiment of the disclosure, determining the frequency domain resource related to the physical uplink shared channel (PUSCH) transmission includes determining the frequency domain resource related to the PUSCH transmission based on indication information, the indication information includes at least one information of a number and/or a location of a downlink frequency domain resource unit, a number and/or a location of an uplink frequency domain resource unit, a number and/or a location of a flexible frequency domain resource unit and a number and/or a location of a frequency domain resource unit for a guard band.

According to the embodiment of the disclosure, the frequency domain resource available for the PUSCH transmission is an available frequency domain resource within a service cell, a carrier or a bandwidth part (BWP).

According to an embodiment of the disclosure, the frequency domain resource unavailable for the PUSCH transmission is one of the following:
a frequency domain resource except for an uplink frequency domain
resource,
a frequency domain resource except for an uplink frequency domain resource and flexible frequency domain resource,
a downlink frequency domain resource,
a downlink frequency domain resource and a flexible frequency domain resource, and
a downlink frequency domain resource and a guard band frequency domain resource.

According to an embodiment of the disclosure, the frequency domain resource available for the PUSCH transmission is one of the following:
an uplink frequency domain resource,
an uplink frequency domain resource and a flexible frequency domain resource,
a frequency domain resource except for a downlink frequency domain resource,
a frequency domain resource except for a downlink frequency domain resource and a flexible frequency domain resource, and
a frequency domain resource except for a downlink frequency domain resource and a guard band frequency domain resource.

According to an embodiment of the disclosure, the signaling indication includes at least one of a high-layer signaling configuration, a media access layer signaling indication or a physical layer signaling indication.

According to an embodiment of the disclosure, the method further comprises determining power headroom of the PUSCH based on at least one of the following:
the frequency domain resource available for the PUSCH transmission among the frequency domain resource allocated to the PUSCH, and
the frequency domain resource allocated to the PUSCH.

In accordance with another aspect of the disclosure, a user equipment (UE) in a wireless communication network is provided. The UE includes a transceiver and a controller, wherein the controller is coupled with the transceiver and configured to perform the method according to one of the above embodiments.

By using the application, a reasonable power may be allocated to data more accurately, the reception performance of data may be better ensured, and power may be saved as much as possible on the premise of ensuring the reception performance of data.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless network according to an embodiment of the disclosure;

FIGS. 2A and 2B illustrate wireless transmission and reception paths according to various embodiments of the disclosure;

FIG. 3A illustrates a user equipment according to an embodiment of the disclosure;

FIG. 3B illustrates a base station according to an embodiment of the disclosure;

FIG. 4 illustrates an allocation of an uplink and a downlink transmission resource according to an embodiment of the disclosure;

FIG. 5 illustrates a flowchart of a method performed by user equipment (UE) according to an embodiment of the disclosure;

FIG. 6 illustrates determining an unavailable frequency domain resource according to an embodiment of the disclosure;

FIG. 7 illustrates determining an unavailable frequency domain resource according to an embodiment of the disclosure; and

FIG. 8 illustrates a block diagram of device according to an embodiment of the disclosure;

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein may be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

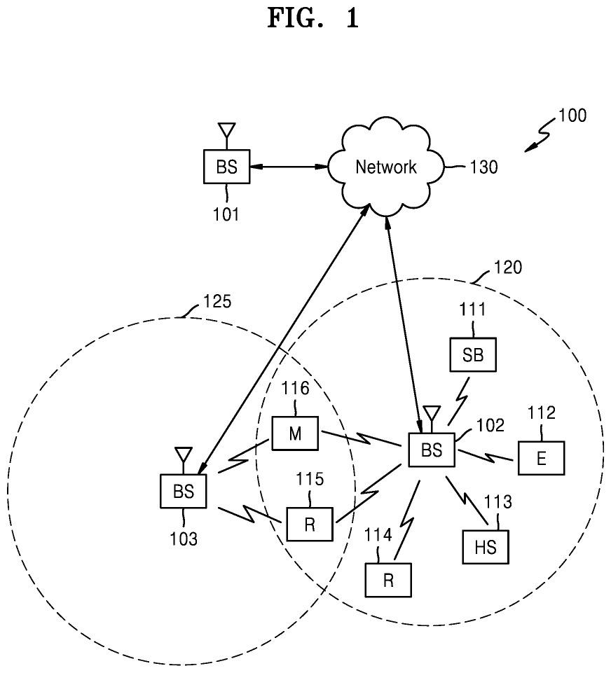

FIG. 1 illustrates a wireless network according to an embodiment of the disclosure.

Referring to FIG. 1, the embodiment of a wireless network 100 shown in FIG. 1 is for illustration only. Other embodiments of the wireless network 100 may be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet protocol (IP) network 130, such as the Internet, a private IP network, or other data networks.

Depending on a type of the network, other well-known terms, such as “base station” or “access point” may be used instead of “gNodeB” or “gNB”. For convenience, the terms “gNodeB” and “gNB” are used in this patent document to refer to network infrastructure components that provide wireless access for remote terminals. And, depending on the type of the network, other well-known terms, such as “mobile station”, “user station”, “remote terminal”, “wireless terminal” or “user apparatus” may be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of user equipment (UEs) within a coverage area 120 of gNB 102. The first plurality of UEs include a UE 111, which may be located in a small business (SB), a UE 112, which may be located in an enterprise (E), a UE 113, which may be located in a Wi-Fi hotspot (HS), a UE 114, which may be located in a first residence (R), a UE 115, which may be located in a second residence (R), a UE 116, which may be a mobile device (M), such as a cellular phone, a wireless laptop computer, a wireless personal digital assistant (PDA), or the like. GNB 103 provides wireless broadband access to network 130 for a second plurality of UEs within a coverage area 125 of gNB 103. The second plurality of UEs include a UE 115 and a UE 116. In some embodiments of the disclosure, one or more of gNBs 101-103 may communicate with each other and with UEs 111-116 using 5G, long term evolution (LTE), LTE advanced (LTE-A), WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described below, one or more of gNB 101, gNB 102, and gNB 103 may include a two-dimensional (2D) antenna array as described in embodiments of the disclosure. In some embodiments of the disclosure, one or more of gNB 101, gNB 102, and gNB 103 support codebook designs and structures for systems with 2D antenna arrays.

Although FIG. 1 illustrates an example of the wireless network 100, various changes may be made to FIG. 1. The wireless network 100 may include any number of gNBs and any number of UEs in any suitable arrangement, for example. Furthermore, gNB 101 may directly communicate with any number of UEs and provide wireless broadband access to the network 130 for those UEs. Similarly, each gNB 102-103 may directly communicate with the network 130 and provide direct wireless broadband access to the network 130 for the UEs. In addition, gNB 101, 102 and/or 103 may provide access to other or additional external networks, such as external telephone networks or other types of data networks.

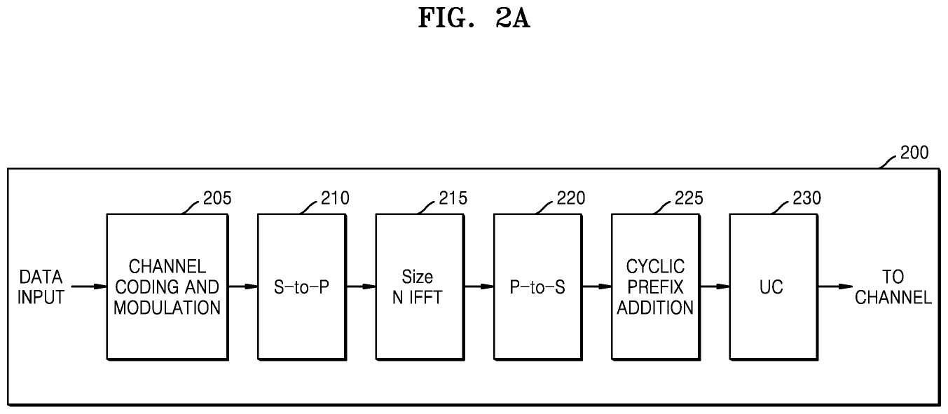

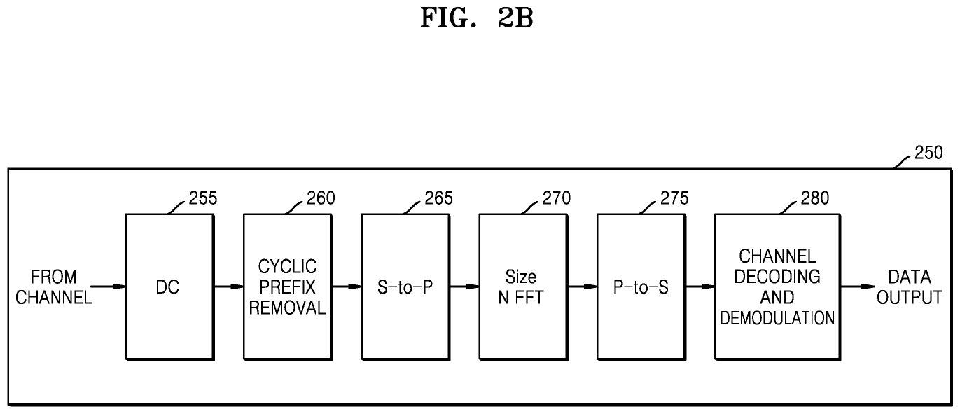

FIGS. 2A and 2B illustrate wireless transmission and reception paths according to various embodiments of the disclosure.

Referring to FIGS. 2A and 2B, in the following description, the transmission path 200 may be described as being implemented in a gNB, such as gNB 102, and the reception path 250 may be described as being implemented in a UE, such as UE 116. However, it should be understood that the reception path 250 may be implemented in a gNB and the transmission path 200 may be implemented in a UE. In some embodiments of the disclosure, the reception path 250 is configured to support codebook designs and structures for systems with 2D antenna arrays as described in embodiments of the disclosure.

The transmission path 200 may include a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 may include a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 may receive a set of information bits, applies coding (such as low density parity check (LDPC) coding), and modulate the input bits (such as using quadrature phase shift keying (QPSK) or quadrature amplitude modulation (QAM)) to generate a sequence of frequency-domain modulated symbols. The serial-to-parallel (S-to-P) block 210 may convert (such as demultiplexes) serial modulated symbols into parallel data to generate N parallel symbol streams, where N is a size of the IFFT/FFT used in gNB 102 and UE 116. The size N IFFT block 215 may perform IFFT operations on the N parallel symbol streams to generate a time-domain output signal. The parallel-to-serial block 220 may convert (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal may also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The Size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B may be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms may be used, such as discrete Fourier transform (DFT) and inverse discrete Fourier transform (IDFT) functions. It should be understood that for DFT and IDFT functions, the value of variable N may be any integer (such as 1, 2, 3, 4, or the like), while for FFT and IFFT functions, the value of variable N may be any integer which is a power of 2 (such as 1, 2, 4, 8, 16, or the like).

Although FIGS. 2A and 2B illustrate examples of wireless transmission and reception paths, various changes may be made to FIGS. 2A and 2B. For example, various components in FIGS. 2A and 2B may be combined, further subdivided or omitted, and additional components may be added according to specific requirements. Furthermore, FIGS. 2A and 2B are intended to illustrate examples of types of transmission and reception paths that may be used in a wireless network. Any other suitable architecture may be used to support wireless communication in a wireless network.

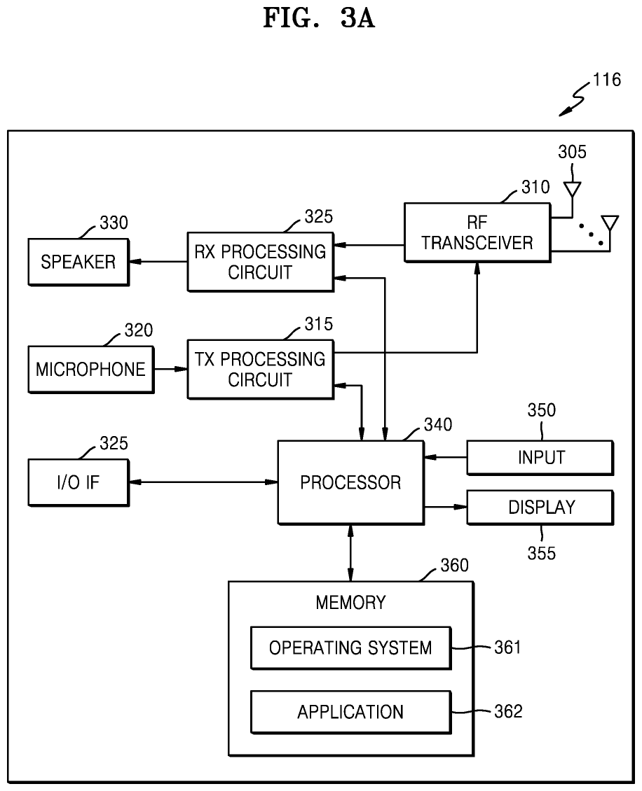

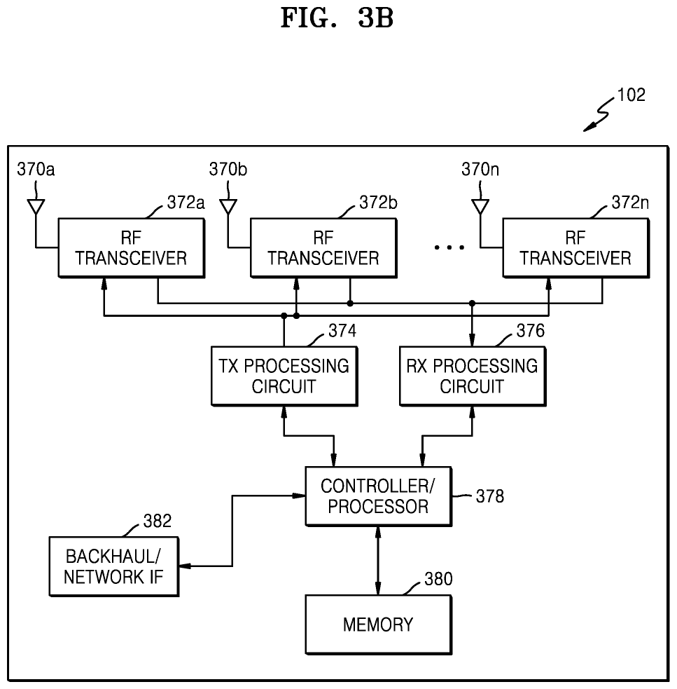

FIG. 3A illustrates a UE according to an embodiment of the disclosure.

Referring to FIG. 3A, the embodiment of UE 116 shown in FIG. 3A is for illustration only, and UEs 111-115 of FIG. 1 may have the same or similar configuration. However, a UE has various configurations, and FIG. 3A does not limit the scope of the disclosure to any specific implementation of the UE.

UE 116 may include an antenna 305, a radio frequency (RF) transceiver 310, a transmission (TX) processing circuit 315, a microphone 320, and a reception (RX) processing circuit 325. UE 116 may include a speaker 330, a processor/controller 340, an input/output (I/O) interface 345, an input device(s) 350, a display 355, and a memory 360. The memory 360 may include an operating system (OS) 361 and one or more applications 362.

The RF transceiver 310 may receive an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 may receive analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 may include one or more processors or other processing devices and execute an OS 361 stored in the memory 360 in order to control the overall operation of UE 116. For example, the processor/controller 340 may control the reception of forward channel signals and the transmission of backward channel signals through the RF transceiver 310, the RX processing circuit 325 and the TX processing circuit 315 according to well-known principles. In some embodiments of the disclosure, the processor/controller 340 may include at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 may move data into or out of the memory 360 as required by an execution process. In some embodiments of the disclosure, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices, such as laptop computers and handheld computers. I/O interface 345 is a communication path between these accessories and the processor/controller 340.

The processor/controller 340 is also coupled to the input device(s) 350 and the display 355. An operator of UE 116 may input data into UE 116 using the input device(s) 350. The display 355 may be a liquid crystal display or other display capable of presenting text and/or at least limited graphics (such as from a website). The memory 360 is coupled to the processor/controller 340. A part of the memory 360 may include a random access memory (RAM), while another part of the memory 360 may include a flash memory or other read-only memory (ROM).

Although FIG. 3A illustrates an example of UE 116, various changes may be made to FIG. 3A. For example, various components in FIG. 3A may be combined, further subdivided or omitted, and additional components may be added according to specific requirements. As a specific example, the processor/controller 340 may be divided into a plurality of processors, such as one or more central processing units (CPUs) and one or more graphics processing units (GPUs). Furthermore, although FIG. 3A illustrates that the UE 116 is configured as a mobile phone or a smart phone, UEs may be configured to operate as other types of mobile or fixed devices.

FIG. 3B illustrates a gNB according to an embodiment of the disclosure.

Referring to FIG. 3B, the embodiment of gNB 102 shown in FIG. 3B is for illustration only, and other gNBs of FIG. 1 may have the same or similar configuration. However, a gNB has various configurations, and FIG. 3B does not limit the scope of the disclosure to any specific implementation of a gNB. It should be noted that gNB 101 and gNB 103 may include the same or similar structures as gNB 102.

As shown in FIG. 3b, gNB 102 may include a plurality of antennas 370a-370n, a plurality of RF transceivers 372a-372n, a transmission (TX) processing circuit 374, and a reception (RX) processing circuit 376. In certain embodiments of the disclosure, one or more of the plurality of antennas 370a-370n may include a 2D antenna array. gNB 102 also includes a controller/processor 378, a memory 380, and a backhaul or network interface 382.

RF transceivers 372a-372n may receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 may receive analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 may include one or more processors or other processing devices that control the overall operation of gNB 102. For example, the controller/processor 378 may control the reception of forward channel signals and the transmission of backward channel signals through the RF transceivers 372a-372n, the RX processing circuit 376 and the TX processing circuit 374 according to well-known principles. The controller/processor 378 may also support additional functions, such as higher-level wireless communication functions. For example, the controller/processor 378 may perform a blind interference sensing (BIS) process, such as that performed through a BIS algorithm, and decode a received signal from which an interference signal is subtracted. A controller/processor 378 may support any of a variety of other functions in gNB 102. In some embodiments of the disclosure, the controller/processor 378 includes at least one microprocessor or microcontroller.

The controller/processor 378 is also capable of executing programs and other processes residing in the memory 380, such as a basic OS. The controller/processor 378 may also support channel quality measurement and reporting for systems with 2D antenna arrays as described in embodiments of the disclosure. In some embodiments of the disclosure, the controller/processor 378 supports communication between entities, such as web real-time communications (RTCs). The controller/processor 378 may move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 may support communication over any suitable wired or wireless connection(s). For example, when gNB 102 is implemented as a part of a cellular communication system, such as a cellular communication system supporting 5G or new radio access technology or new radio (NR), LTE or LTE-A, the backhaul or network interface 382 may allow gNB 102 to communicate with other gNBs through wired or wireless backhaul connections. When gNB 102 is implemented as an access point, the backhaul or network interface 382 may allow gNB 102 to communicate with a larger network, such as the Internet, through a wired or wireless local area network or through a wired or wireless connection. The backhaul or network interface 382 may include any suitable structure that supports communication through a wired or wireless connection, such as an Ethernet or an RF transceiver.

The memory 380 is coupled to the controller/processor 378. A part of the memory 380 may include an RAM, while another part of the memory 380 may include a flash memory or other ROMs. In some embodiments of the disclosure, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described below, the transmission and reception paths of gNB 102 (implemented using RF transceivers 372a-372n, TX processing circuit 374 and/or RX processing circuit 376) support aggregated communication with frequency domain duplexing (FDD) cells and time domain duplexing (TDD) cells.

Although FIG. 3B illustrates an example of gNB 102, various changes may be made to FIG. 3B. For example, gNB 102 may include any number of each component shown in FIG. 3A. As a specific example, the access point may include many backhaul or network interfaces 382, and the controller/processor 378 may support routing functions to route data between different network addresses. As a specific example, although shown as including a single instance of the TX processing circuit 374 and a single instance of the RX processing circuit 376, gNB 102 may include multiple instances of each (such as one for each RF transceiver).

The various embodiments of the disclosure are further described below in conjunction with the accompanying drawings.

The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples may be made without departing from the scope of the disclosure.

Communication systems are usually divided into time domain duplexing (TDD) and frequency domain duplexing (FDD) systems. In a TDD system, the base station may configure the uplink and downlink attributes in different time resources on one carrier through semi-static signaling and dynamic signaling, namely uplink transmission slots/symbols, downlink transmission slots/symbols and flexible slots/symbols. In a FDD system, the base station may configure the different time resources of the uplink carrier of a pair of uplink and downlink carriers as uplink transmission slots/symbols or flexible slots/symbols, and configure the different time resources of the downlink carrier as downlink transmission slots/symbols or flexible slots/symbols, respectively.

Compared with the FDD system, the time delay of uplink or downlink transmissions in the TDD system may be relatively large because uplink and downlink transmissions are time division multiplexed. For example, according to one uplink and downlink configuration, in one cycle of 10 ms (millisecond), only a slot of 1 ms is an uplink transmission, and other slots are a downlink transmission or a flexible transmission, and the maximum delay of an uplink transmission is 10 ms. In order to reduce the transmission delay, dividing a part of frequency domain resources in one carrier into an uplink transmission and dividing the other part of the resources into a downlink transmission may be considered. In order to reduce the mutual influence of uplink and downlink transmissions in the same carrier, the uplink and downlink interference may be reduced by the way of a guard interval and filtering, or the like. Furthermore, using a part of a frequency domain resource in one carrier for both uplink and downlink transmissions may be considered, so as to improve the resource utilization rate.

The embodiment of the application proposes to improve the existing power control method of uplink signals based on the new uplink and downlink transmission way, so as to ensure the performance of data transmission and save power as much as possible on the premise of ensuring the data transmission performance.

In the TDD system, the base station may indicate that one slot or symbol is an uplink symbol, a downlink symbol or a flexible transmission symbol, and the UE determines the uplink and downlink transmission direction of each symbol/slot of one carrier/serving cell according to the indication information. Usually, in the same symbol of one carrier/serving cell, only one direction of transmission is supported, that is, an uplink or a downlink transmission, thus the base station only needs to indicate the uplink and downlink transmission direction in the time dimension. The base station may periodically indicate, for example, the periodic slot configuration through high-layer signaling, or the slot format within a period of time through dynamic signaling. The uplink and downlink attributes of each frequency domain resource within each slot/symbol are determined through the slot configuration/format: for an uplink transmission, for a downlink transmission or a flexible transmission. The flexible slot/symbol may be used as both the uplink transmission and the downlink transmission, but only as one direction of transmission at a time instant. In the FDD system, the base station may indicate uplink or flexible transmission symbols/slots for uplink carriers/serving cells, and base station may indicate downlink or flexible transmission symbols/slots for downlink carriers/serving cells. The first type of cell common UL/DL information may include information of uplink and downlink attributes in time dimension, and the first type of cell common UL/DL information may be used to indicate which periods, which slots/symbols within a period are uplink, downlink or flexible slots/symbols, respectively, and the indicated uplink and downlink attributes are applicable to all frequency domain resources within each slot/symbol of this cell, that is, all frequency domain resources within the bandwidth of this carrier/serving cell have the same uplink and downlink attributes within one slot/symbol.

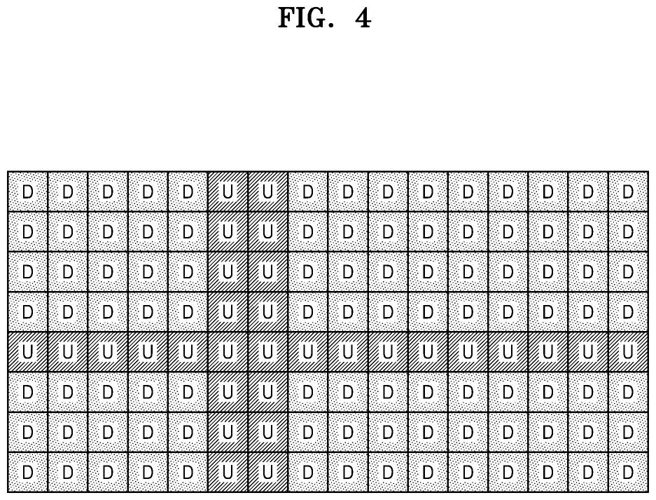

In order to allocate uplink and downlink transmission resources more efficiently, the granularity of uplink and downlink transmission resources may be further reduced from one symbol/slot to a part of a frequency domain resource in one symbol/slot through configuration information, that is, different frequency domain resources in one symbol of one carrier/serving cell may be allocated with different transmission directions. The configuration information includes cell common UL/DL information and/or UE specific UL/DL information. The cell common UL/DL information may include information of uplink and downlink attributes in time dimension and frequency dimension, and the cell common UL/DL information may be used to indicate which frequency domain resources of which slots/symbols are uplink, downlink or flexible transmission resources. Alternatively, the common UL/DL information may be used to indicate which frequency domain resources of which slots/symbols are uplink resources, downlink resources or unavailable resources for transmission. Furthermore, for the same time-frequency resources, the base station may also allocate uplink and downlink transmissions at the same time to implement full duplex multiplexing. The base station may also configure user specific UL/DL information, for example, configure user specific UL/DL information for each serving cell of the UE or configure user specific UL/DL information for each BWP of the UE. According to the configured user specific UL/DL information, the UE may determine that a part of frequency domain resources within one symbol or slot are uplink transmission resources and a part of frequency domain resources within one symbol or slot are downlink transmission resources, as shown in FIG. 4.

FIG. 4 illustrates an allocation of an uplink and a downlink transmission resource according to an embodiment of the disclosure.

Referring to FIG. 4, the uplink bandwidth part (BWP) is made to contain downlink frequency domain resources, which include at least one frequency domain resource unit, for example: a physical resource block (PRB) or a resource block (RB) or a downlink resource element (RE) or resource element group (REG, RE Group), alternatively, the downlink BWP contains uplink frequency domain resources, for example, uplink PRB, RB or uplink RE and REG. The problem caused by this is that some PRB through the frequency domain resource assignment (FDRA) may be actually unavailable, for example, the frequency domain resources allocated for the physical uplink shared channel (PUSCH) include downlink frequency domain resources (for example, PRB, RB, RE, REG) or frequency domain resources served as an isolation (for example, PRB, RB, RE, REG), then the downlink frequency domain resources (for example, PRB, RB, RE) or frequency domain resources (for example, PRB, RB, RE, REG)served as an isolation are unavailable frequency domain resources (for example, PRB, RB, RE, REG), which may influence the data reception performance.

The number of frequency domain resources (for example, PRB, RB, RE, REG, or the like) of transmission data is the number of frequency domain resources (e.g., PRB, RB, RE, REG, or the like) indicated by FRDA in downlink control information (DCI) for scheduling the PUSCH or the number of frequency domain resources (e.g., PRB, RB, RE, REG, or the like) configured for PUSCH utilizing high-layer signaling.

Thereafter, the transmission power of the PUSCH is determined according to the number of indicated frequency domain resources (taking PRB as an example). The transmission power of the PUSCH is calculated according to the following Equation 1:

$$Equation 1$$

$${P}_{PUSCH} = min ( {P}_{CMAX} , \text{} {P}_{0 \_ PUSCH} + 10 {log}_{10} ( {2}^{μ} \cdot {M}_{RB}^{PUSCH} + α \cdot PL + {Δ}_{TF} + f ) )$$

In the Equation, P_{CMAX} is a maximum transmission power of UE, the P_{0_PUSCH} and α are an open-loop power control parameter, PL is a path loss, Δ_{TF} is a power control parameter related to the modulating and coding state, and μ is a subcarrier space configuration, M_{RB}^{PUSCH} is a number of PRBs (sometimes called a number of RBs) allocated to the PUSCH.

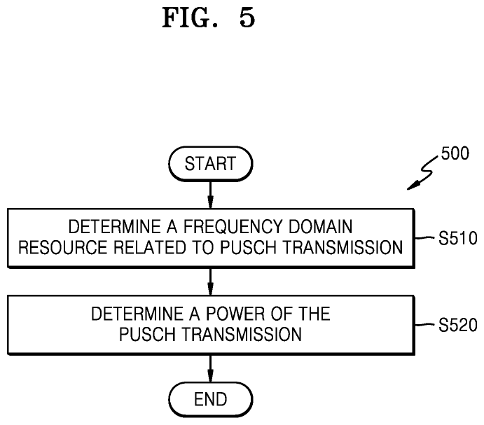

FIG. 5 illustrates a flowchart of a method 500 for transmitting a PUSCH according to an embodiment of the disclosure. The method 500 is implemented on the UE side.

Referring to FIG. 5, in operation S510, the UE may determine a frequency domain resource related to PUSCH transmission according to indication information.

In operation S520, the UE determines the power of the PUSCH transmission for transmitting PUSCH according to the frequency domain resource related to the PUSCH transmission.

In operation S510, for example, the UE may receive the indication information from the base station. Herein, the indication information may include first indication information and second indication information.

The UE may determine a frequency domain resource allocated to the PUSCH according to the first indication information. The UE may determine an available or unavailable frequency domain resource for the PUSCH transmission according to the second indication information.

In operation S520, for example, the UE may determine the power of PUSCH transmission according to the frequency domain resource allocated to the PUSCH or the available frequency domain resource for the PUSCH transmission among the frequency domain resource allocated to the PUSCH.

The above operations are only used to denote different operations, not to indicate the sequence of operations.

The indication information may be high-layer signaling configuration information, information indicated by media access layer signaling, physical layer signaling and a reference signal. The high-layer signaling configuration information is semi-static configuration information, the advantage of using semi-static configuration information to indicate the unavailable frequency domain resource is that this information is reliable and will not cause different understanding of the unavailable resource between the base station and the UE. The information indicated by the physical layer signaling and the reference signal is the information indicated dynamically, the advantage of using dynamic information to indicate the unavailable frequency domain resource is that this information is indicated in time and the unavailable resource may be indicated to UE more quickly. The indication information for determining the unavailable frequency domain resource, for example the second indication information, may be at least one indication information of high-layer signaling configuration information, information indicated by media access layer signaling, physical layer signaling and a reference signal (it may also be other types of indication information). Specifically, the information may be preset or may be determined by the UE according to the indication information provided by the base station, for example, the UE determines the unavailable frequency domain resource according to the high-layer signaling configuration information if UE receives the high-layer signaling configuration information transmitted by the base station to the UE.

Alternatively or additionally, if the UE receives the physical layer signaling indication transmitted by the base station to the UE, the UE determines the unavailable frequency domain resource according to the physical layer signaling indication. Alternatively or additionally, if the UE receives the physical layer signaling indication transmitted by the base station to the UE, the UE determines the unavailable frequency domain resource according to the physical layer signaling indication, if the UE does not receive the physical layer signaling indication transmitted by the base station to the UE and the UE receives the high-layer signaling configuration information transmitted by the base station to the UE, the UE determines the unavailable frequency domain resource according to the high-layer signaling configuration information.

The content of indication information may be a downlink frequency domain resource, which includes at least one of the number and/or location of at least one frequency domain resource unit (e.g., PRB, RB, RE, REG, or the like), the number and/or location of the uplink frequency domain resource (e.g., PRB, RB, RE, REG, or the like), the number and/or location of the flexible frequency domain resource (e.g., PRB, RB, RE, REG, or the like), the number and/or location of the frequency domain resource of the guard band (e.g., PRB, RB, RE, REG, or the like).

The unavailable frequency domain resource may be represented with the unavailable frequency domain resource (for example, PRB, RB, RE, REG, or the like), the unavailable PRB may be taken as an example herein for description, and it may be extended to unavailable RB, RE, REG, or the like. There are several examples to determine the unavailable frequency domain resources (the following examples take PRB as an example).

### Example 1.1

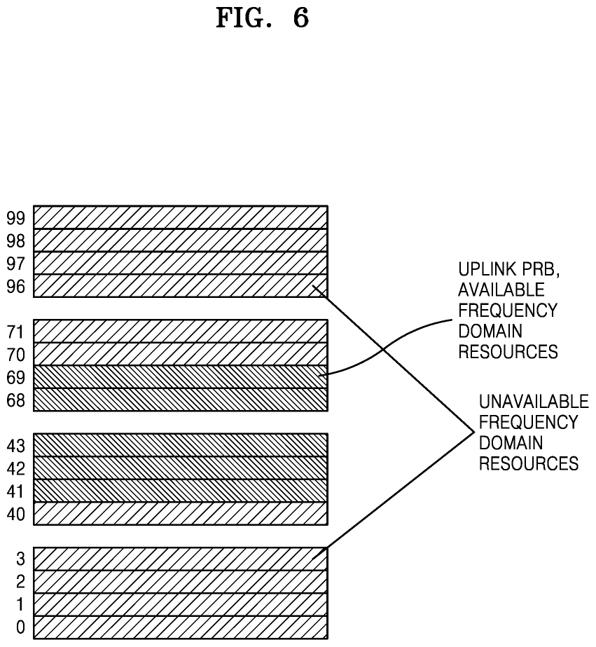

For the PUSCH, only the indicated uplink PRBs are available frequency domain resources, and all the others except for the indicated uplink PRBs are unavailable frequency domain resources. For example, one carrier may include 100 PRBs with serial numbers of 0-99, wherein the serial numbers of 41-69 are uplink PRBs, serial numbers of 41-69 are available frequency domain resources for the PUSCH transmission, and PRBs with serial numbers 0-40 and 70-99 are unavailable frequency domain resources for the PUSCH transmission, as shown in FIG. 6.

FIG. 6 illustrates determining an unavailable frequency domain resource according to an embodiment of the disclosure.

### Example 1.2

Referring to FIG. 6, for the PUSCH, the indicated uplink PRBs and the indicated flexible PRBs are available frequency domain resources, and all the others except for the indicated uplink PRBs and the indicated flexible PRBs are unavailable frequency domain resources. For example, one carrier includes 100 PRBs with serial numbers of 0-99, wherein the serial numbers of 0-30 and 80-99 are uplink PRBs, serial numbers of 31-50 are flexible PRBs, then PRBs with serial numbers of 0-50 and 80-99 are available frequency domain resources for the PUSCH transmission, and serial numbers of 51-79 are unavailable frequency domain resources for the PUSCH transmission.

### Example 1.3

For the PUSCH, the indicated downlink PRBs are unavailable frequency domain resources, and all the others except for the indicated downlink PRBs are available frequency domain resources. For example, one carrier may include 100 PRBs, with serial numbers of 0-99, wherein the PRB with serial numbers of 31-50 are downlink PRBs, PRBs with serial numbers of 0-30 and 51-99 are available frequency domain resources for the PUSCH transmission, and PRBs with serial numbers of 31-50 are unavailable frequency domain resources for the PUSCH transmission.

### Example 1.4

For the PUSCH, the indicated downlink PRBs and flexible PRBs are unavailable frequency domain resources for the PUSCH, and all the others except for the indicated downlink PRBs and the flexible PRBs are available frequency domain resources for the PUSCH transmission. For example, one carrier may include 100 PRBs with serial numbers of 0-99, wherein the PRBs with serial numbers of 31-50 are downlink PRBs, PRBs with serial numbers of 35-70 are flexible PRBs, and PRBs of 0-30 and 71-99 are available frequency domain resources for the PUSCH transmission.

### Example 1.5

For the PUSCH, the indicated downlink PRBs and PRBs for the guard band are unavailable frequency domain resources for the PUSCH transmission, and all the others except for the indicated downlink PRBs and the PRBs for the guard band are available frequency domain resources for the PUSCH transmission. For example, one carrier may include 100 PRBs with serial numbers of 0-99, wherein the PRBs with serial numbers of 51-70 are downlink PRBs, PRBs with serial numbers of 41-50 and 71-80 are PRBs for the guard band, and PRBs of 0-40 and 81-99 are available frequency domain resources for the PUSCH transmission. The PRBs with serial numbers of 41-80 are unavailable frequency domain resources for the PUSCH transmission.

The available frequency domain resources above for the PUSCH transmission may be available frequency domain resources within one service cell (or one carrier or one BWP). The UE receives the PRBs indicated by FDRA of scheduled PUSCH (the scheduled PUSCH includes PUSCH dynamically scheduled by DCI and also includes static and semi-persist scheduled (SPS) PUSCH), and the PRBs indicated by FDRA may not all be PRBs for the PUSCH transmission, that is, among the PRBs indicated by FDRA, there are PRBs unavailable for the PUSCH transmission, it may also be said that only a part of the PRBs among the PRBs indicated by FDRA may be used for the PUSCH transmission.

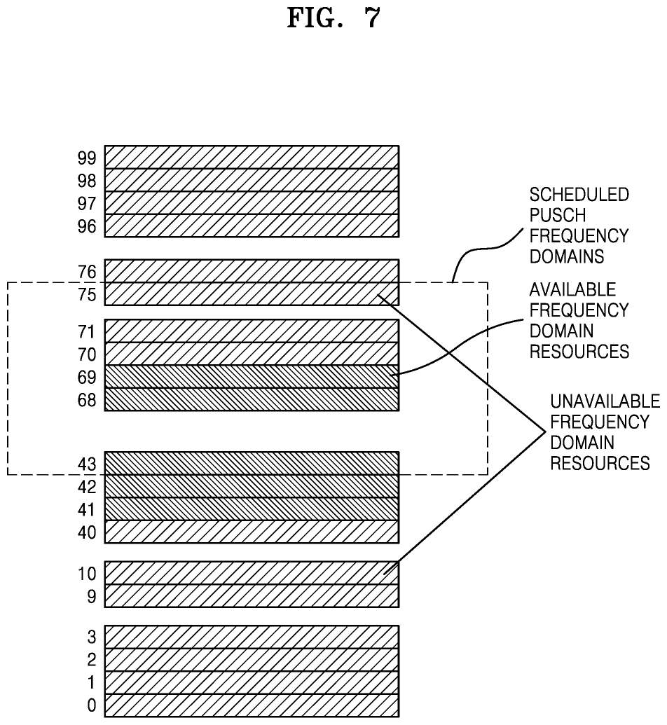

FIG. 7 illustrates determining an unavailable frequency domain resource according to an embodiment of the disclosure.

Referring to FIG. 7, one carrier may include 100 PRBs with serial numbers of 0-99, herein, the serial numbers of 0-40 and 70-99 are PRBs unavailable for the PUSCH transmission, the PRBs with serial number 41-69 are PRBs available for the PUSCH transmission, and the PRBs indicated by FDRA in DCI for scheduling the PUSCH are the PRBs with serial numbers 45-75, as such, herein the PRBs with serial numbers of 45-69 are the PRBs available for the PUSCH transmission, and the PRBs with serial numbers of 70-75 are the PRBs unavailable for the PUSCH transmission.

In the above case, there are several methods to determine the PUSCH transmission power (taking PRBs as an example).

### Method 1

According to the number L of PRBs available for PUSCH transmission among the PRBs allocated to PUSCH served as M_{RB}^{PUSCH}, the power of PUSCH transmission P_{PUSCH} is calculated according to Equation 1. And when transmitting the PUSCH, the PUSCH is transmitted with the power P_{PUSCH} only in the PRBs available for PUSCH transmission, and the power on each PRB is P_{PUSCH}/L. For example, one carrier includes 100 PRBs with serial numbers of 0-99, herein the serial numbers of 0-40 and 70-99 are the PRBs unavailable for the PUSCH transmission, the PRBs with serial numbers of 41-69 are the PRBs available for the PUSCH transmission, and the PRBs indicated by FDRA in DCI for scheduling PUSCH are the PRBs with serial numbers of 43-75, the number M of PRBs allocated by the scheduled DCI to the PUSCH is equal to 75−43+1=33, herein the PRBs with serial number 43-69 are the PRBs available for the PUSCH transmission among the PRBs allocated by the scheduled DCI to the PUSCH, the number of PRBs available for the PUSCH transmission among the number M=33 of PRBs allocated by the scheduled DCI to the PUSCH is L=69−43+1=27. M_{RB}^{PUSCH} equaling to 27 is substituted into Equation 1 to calculate the power P_{PUSCH} of the PUSCH transmission, and when transmitting PUSCH, the PUSCH is transmitted with the power P_{PUSCH} only in 27 PRBs available for the PUSCH transmission, and the power on each PRB is P_{PUSCH}/27.

The advantage of taking this method is that power is only allocated to PRBs available for the transmission, which may save power.

### Method 2

According to number M of the PRBs allocated to PUSCH served as M_{RB}^{PUSCH}, the power P_{PUSCH} for the PUSCH transmission is calculated according to Equation 1. And when transmitting the PUSCH, the PUSCH is transmitted with the power P_{PUSCH} only in the number L of PRBs available for the PUSCH transmission, and the power on each PRB is P_{PUSCH}/L. For example, one carrier includes 100 PRBs with serial numbers of 0-99, herein the serial numbers of 0-40 and 70-99 are the PRBs unavailable for the PUSCH transmission, the PRBs with serial numbers of 41-69 are the PRBs available for the PUSCH transmission, and PRBs indicated by FDRA in DCI for scheduling PUSCH are the PRBs with serial numbers of 43-75, the number M of PRBs allocated by the scheduled DCI to the PUSCH is equal to 75−43+1=33, herein the PRBs with serial numbers 43-69 are the PRBs available for the PUSCH transmission among the PRBs allocated by the scheduled DCI to the PUSCH, the number of PRBs available for the PUSCH transmission among the number M=33 of PRBs allocated by the scheduled DCI to the PUSCH is L=69−43+1=27. M_{RB}^{PUSCH} equaling to 33 is substituted into Equation 1 to calculate the power P_{PUSCH} of the PUSCH transmission, and when transmitting PUSCH, the PUSCH is transmitted with the power P_{PUSCH} only in 27 PRBs available for the PUSCH transmission, and the power on each PRB is P_{PUSCH}/27.

The advantage of taking this method is to make full use of the allocated power to improve the reception performance of the PUSCH.

### Method 3

According to the signaling indication or according to the defined conditions, one of the above-described method 1 and method 2 is determined to be taken to determine the transmission power of the PUSCH transmission.

An example method is that the UE receives the high-layer signaling configuration, the media access layer signaling indicates or the physical layer signaling indicates to take one of the above-described method 1 and method 2 to determine the transmission power of the PUSCH transmission. The advantage of this method is that the base station may flexibly determine whether to make full use of the allocated power to improve the reception performance of PUSCH or save power.

An example method is to determine to take one of the above-described method 1 and method 2 according to the defined condition to determine the transmission power of PUSCH transmission, for example, when the predefined condition is met, the above-described method 2 is taken to determine the transmission power of PUSCH transmission, and when a defined condition is not met, the above-described method 1 is taken to determine the transmission power of PUSCH transmission. The predefined condition is that the PUSCH is a continuous plurality of PUSCHs, and the frequency domain resources scheduled by some PUSCHs in the continuous plurality of PUSCHs includes unavailable PRBs, and the frequency domain resources scheduled by some PUSCHs does not include the unavailable PRBs, for example, the PUSCH is a continuous plurality of PUSCHs, and among the continuous plurality of PUSCHs, a frequency domain resource scheduled by PUSCH including the unavailable PRBs and an adjacent frequency domain resource scheduled by PUSCH not including the unavailable PRBs exist, or the PUSCH is a continuous plurality of PUSCHs, and among the continuous plurality of PUSCHs, one frequency domain resource scheduled by PUSCH including the unavailable PRBs exists and the adjacent frequency domain resource scheduled by PUSCH not including the unavailable PRBs does not exist, or the like. The defined condition may also have other conditions, which are not limited here. The advantage of taking this method is that it may be flexible to determine whether to make full use of the allocated power to improve the reception performance of PUSCH or save power according to the condition, and it does not need signaling indications.

For the report of power headroom (PH) of PUSCH, taking PRBs as an example, the PH of PUSCH is calculated according to the following Equation 2:

$$Equation 2$$

$$PH = {P}_{CMAX} - {P}_{0 \_ PUSCH} + 10 {log}_{10} ( {2}^{μ} \cdot {M}_{RB}^{PUSCH} + α \cdot PL + {Δ}_{TF} + f )$$

In the Equation, P_{CMAX} is a maximum transmission power of UE, the P_{0_PUSCH} and α are an open-loop power control parameter, PL is a path loss, Δ_{TF} is a power control parameter related to the modulating and coding state, and μ is a subcarrier space configuration, M_{RB}^{PUSCH} is a number of PRBs (sometimes called a number of RB) allocated to PUSCH.

However, a part of PRBs among the PRBs in the scheduled PUSCH resources may be unavailable resources, at this time, the following methods may be used to report PH.

### Method 1

According to the number L of PRBs available for the PUSCH transmission among the PRBs allocated to PUSCH served as M_{RB}^{PUSCH}, the Power Headroom PH for PUSCH transmission is calculated according to Equation 2.

The advantage of taking this method is that it may make the understanding of the base station and UE the same.

### Method 2

According to number M of the PRBs allocated to PUSCH served as M_{RB}^{PUSCH}, the Power Headroom PH for the PUSCH transmission is calculated according to Equation 2.

The advantage of taking this method is that it may make the understanding of the base station and UE the same.

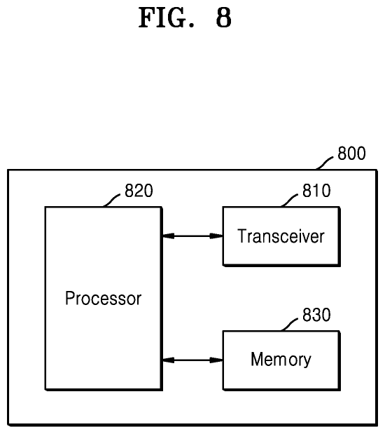

FIG. 8 is a block diagram of a device for implementing according to an embodiment of the disclosure.

Node devices in the network may be used to implement the base station, UE, or the like, of disclosure.

Referring to FIG. 8, a network device 800 according to the disclosure includes a transceiver 810, a controller 820 and a memory 830. The transceiver 810, the controller 820 and the memory 830 are configured to perform the operations of the methods and/or embodiments of the disclosure. Although the transceiver 810, the controller 820 and the memory 830 are shown as separate entities, they may be implemented as a single entity, such as a single chip. The transceiver 810, the controller 820 and the memory 830 may be electrically connected or coupled to each other. The transceiver 810 may transmit signals to and receive signals from other network devices, such as a UE, base stations or core network nodes. The controller 820 may include one or more processing units and may control network devices to perform operations and/or functions according to one of the above embodiments. The memory 830 may store instructions for implementing operations and/or functions of one of the embodiments described above.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication network, the method comprising:
determining a frequency domain resource related to a physical uplink shared channel (PUSCH) transmission based on indication information; and
determining a power of the PUSCH transmission for transmitting PUSCH based on the frequency domain resource related to the PUSCH transmission,
wherein the frequency domain resource related to the PUSCH transmission includes a frequency domain resource allocated to the PUSCH or a frequency domain resource available for the PUSCH transmission among the frequency domain resource allocated to the PUSCH.

2. The method of claim 1, wherein the frequency domain resource allocated to the PUSCH includes a frequency domain resource indicated by a frequency domain resource allocation (FRDA) in downlink control information (DCI) for scheduling the PUSCH or a frequency domain resource configured for the PUSCH using high-layer signaling.

3. The method of claim 1, wherein the frequency domain resource available for the PUSCH transmission among the frequency domain resource allocated to the PUSCH is determined based on the frequency domain resource allocated to the PUSCH and a frequency domain resource available or unavailable for the PUSCH transmission.

4. The method of claim 1, wherein the indication information includes at least one of high-layer signaling configuration information, information indicated by media access layer signaling, information indicated by physical layer signaling, or information indicated by a reference signal.

5. The method of claim 1, further comprising:
determining to calculate the power of the PUSCH transmission by using one of the frequency domain resource allocated to the PUSCH or the frequency domain resource available for the PUSCH transmission among the frequency domain resource allocated to the PUSCH, based on a signaling indication or whether a predefined condition being met.

6. The method of claim 5, wherein the predefined condition includes:
the PUSCH including a continuous plurality of PUSCHs, and among the continuous plurality of PUSCHs, a frequency domain resource scheduled by the PUSCH including the frequency domain resource unavailable for the PUSCH transmission and an adjacent frequency domain resource scheduled by the PUSCH not including the frequency domain resource unavailable for the PUSCH transmission exist; or
the PUSCH including a continuous plurality of PUSCHs, and among the continuous plurality of PUSCHs, one frequency domain resource scheduled by the PUSCH including the frequency domain resource unavailable for the PUSCH transmission exists and the adjacent frequency domain resource scheduled by the PUSCH not including the frequency domain resource unavailable for the PUSCH transmission does not exist.

7. The method of claim 1, further comprising:
determining a power of each frequency domain resource unit available for the PUSCH transmission among the frequency domain resource allocated to the PUSCH, based on the power of the PUSCH transmission and the frequency domain resource available for the PUSCH transmission among the frequency domain resource allocated to the PUSCH.

8. The method of claim 1,
wherein the indication information includes at least one information of a number or a location of a downlink frequency domain resource unit, a number or a location of an uplink frequency domain resource unit, a number or a location of a flexible frequency domain resource unit and a number or a location of a frequency domain resource unit for a guard band.

9. The method of claim 1, wherein the frequency domain resource available for the PUSCH transmission includes an available frequency domain resource within a service cell, a carrier or a bandwidth part (BWP).

10. The method of claim 1, wherein the frequency domain resource unavailable for the PUSCH transmission includes one of:
a frequency domain resource except for an uplink frequency domain resource;
a frequency domain resource except for an uplink frequency domain resource and a flexible frequency domain resource;
a downlink frequency domain resource;
a downlink frequency domain resource and a flexible frequency domain resource;
or
a downlink frequency domain resource and a guard band frequency domain resource.

11. The method of claim 1, wherein the frequency domain resource available for the PUSCH transmission includes one of:
an uplink frequency domain resource;
an uplink frequency domain resource and a flexible frequency domain resource;
a frequency domain resource except for a downlink frequency domain resource;
a frequency domain resource except for a downlink frequency domain resource and a flexible frequency domain resource; or
a frequency domain resource except for a downlink frequency domain resource and a guard band frequency domain resource.

12. The method of claim 5, wherein the signaling indication includes at least one of a high-layer signaling configuration, a media access layer signaling indication, or a physical layer signaling indication.

13. The method of claim 1, further comprising:
determining power headroom of the PUSCH based on at least one of:
the frequency domain resource available for the PUSCH transmission among the frequency domain resource allocated to the PUSCH; or
the frequency domain resource allocated to the PUSCH.

14. A user equipment (UE) in a wireless communication system, the UE comprising:
transceiver; and
at least one processor coupled to the transceiver and configured to:
identify a frequency domain resource related to a physical uplink shared channel (PUSCH) transmission based on indication information, and
identify a power of the PUSCH transmission for transmitting PUSCH based on the frequency domain resource related to the PUSCH transmission,
wherein the frequency domain resource related to the PUSCH transmission includes a frequency domain resource allocated to the PUSCH or a frequency domain resource available for the PUSCH transmission among the frequency domain resource allocated to the PUSCH.

15. The UE of claim 14, wherein the frequency domain resource allocated to the PUSCH includes a frequency domain resource indicated by a frequency domain resource allocation (FRDA) in downlink control information (DCI) for scheduling the PUSCH or a frequency domain resource configured for the PUSCH using high-layer signaling.

16. The UE of claim 14, wherein the frequency domain resource available for the PUSCH transmission among the frequency domain resource allocated to the PUSCH is determined based on the frequency domain resource allocated to the PUSCH and a frequency domain resource available or unavailable for the PUSCH transmission.

17. The UE of claim 14, wherein the indication information includes at least one of high-layer signaling configuration information, information indicated by media access layer signaling, information indicated by physical layer signaling, or information indicated by a reference signal.

18. The UE of claim 14, wherein the at least one processor is further configured to:
determine to calculate the power of the PUSCH transmission by using one of the frequency domain resource allocated to the PUSCH or the frequency domain resource available for the PUSCH transmission among the frequency domain resource allocated to the PUSCH, based on a signaling indication or whether a predefined condition being met.

19. The UE of claim 14, wherein the at least one processor is further configured to:
determine a power of each frequency domain resource unit available for the PUSCH transmission among the frequency domain resource allocated to the PUSCH, based on the power of the PUSCH transmission and the frequency domain resource available for the PUSCH transmission among the frequency domain resource allocated to the PUSCH.

20. One or more non-transitory computer-readable storage media storing computer-executable instructions that, when executed by at least one processor of a user equipment (UE), configure the UE to perform operations comprising:
determining a frequency domain resource related to a physical uplink shared channel (PUSCH) transmission based on indication information; and
determining a power of the PUSCH transmission for transmitting PUSCH based on the frequency domain resource related to the PUSCH transmission,
wherein the frequency domain resource related to the PUSCH transmission includes a frequency domain resource allocated to the PUSCH or a frequency domain resource available for the PUSCH transmission among the frequency domain resource allocated to the PUSCH.
